(19) United States
(12) Patent Application Publication
(10) Pub. No.: US 2014/0279913 A1
(43) Pub. Date: Sep. 18, 2014

(54) FILE SYSTEM REPLICATION

(71) Applicant: Geoffrey Ray Wehrman, Eagan, MN (US)

(72) Inventor: Geoffrey Ray Wehrman, Eagan, MN (US)

(21) Appl. No.: 13/831,745

(22) Filed: Mar. 15, 2013

(51) Int. Cl. G06F 11/14

(52) U.S. Cl. CPC G06F 11/1448
USPC 707/640

(57) ABSTRACT

A data backup system for data and metadata is stored in a file storage system. Data in the file system is stored in a remote low priority data storage system, such as a remote tape storage system, power-managed array of secondary storage disks (MAID), or other lower cost secondary data storage system. Metadata for the file system is stored in a remote higher priority system, such as a remote disk storage system. As such, the data and metadata for a file storage system maintained at a primary location is backed-up in different types of storage systems at a remote location. By storing the data and metadata in different types of storage, the data can be backed up at less cost. In case of a disaster at the primary storage location, a user accessing data from a local server may be switched to access the data and the metadata from the remote server.

### BACKGROUND OF THE INVENTION

1. Field of the Invention

The present invention relates to data storage systems. In particular, the present invention relates to back-up data storage systems.

2. Description of the Related Art

Companies create and use more data than ever before. It is not uncommon for a company to have a need to store one or more petabytes of data.

Dispersed data storage centers provide one possible backup or archive solution to these companies with a need to store large amounts of data. Some companies may desire data protection at different locations with storage that is reconciled across both locations. For example, if a disaster occurs and wipes out the storage at a particular location, it can be helpful to have a backup plan that allows a user consistent access to their data. However, it can be difficult to store large amounts of data to separate locations on hard disc drives. What is needed is a system for backing up large amounts of data which protect against disaster or other catastrophic events.

### SUMMARY OF THE CLAIMED INVENTION

The present invention provides a data backup system for data and metadata stored in a file storage system. Data in the file system is stored in a remote low priority data storage system, such as a remote tape storage system or power-managed array of secondary storage disks (MAID) or other lower cost secondary data storage system. Metadata for the file system is stored in a remote higher priority system, such as a remote disk storage system. As such, the data and metadata for a file storage system maintained at a primary location is backed-up in different types of storage systems at a remote location. By storing the data and metadata in different types of storage, the data can be backed up at less cost. In case of a disaster at the primary storage location, a user accessing data from a local server may be switched to access the data and the metadata from the remote server.

### BRIEF DESCRIPTION OF THE DRAWINGS

FIG. 1 is a block diagram of a data backup system.

FIG. 2 is a method for storing metadata at a remote disc drive.

FIG. 3 is a method for storing metadata and other data at a remote file system.

FIG. 4 is a method for providing a customer with access to a remote system in case of server failure.

FIG. 5 provides a block diagram of a computing device for use with the present invention.

### DETAILED DESCRIPTION

The present invention provides a data backup system for data and metadata stored in a file storage system. Data in the file system is stored in a remote low priority data storage system, such as a remote tape storage system, a power-managed array of secondary storage disks (MAID), or other secondary storage systems. Metadata for the file system is stored in a remote higher priority system, such as a remote disk storage system. As such, the data and metadata for a file storage system maintained at a primary location is backed-up in different types of storage systems at a remote location. By storing the data and metadata in different types of storage, the data can be backed up at less cost. In case of a disaster at the primary storage location, a user accessing data from a local server may be switched to access the data and the metadata from the remote server.

FIG. 1 is a block diagram of a backup system. The system of FIG. 1 includes local data management server 130, local file system 110, local tape device 120, and network 170. Local file system 110 and local tape device 120 each communicate with local data management server 130.

Local file system 110 may include metadata 115. Local tape device 120 may include data 125. The data 125 on local tape device 120 may be backed up to remote tape device 150 over network 170. The local tape device 120 may include a large amount of data. Storing the data on a cheap and relatively inexpensive storage medium such as tape device at a remote location is practical. Metadata 115 may also be served remotely. For example, local data management server 130 may access metadata 115 from the local file system 110 and transmit the metadata to remote data management server 160. Remote data management server 160 may then store the received metadata into remote file system 140. The resulting metadata copy 145 is stored in remote file system 140 and corresponds to a copy of data 155 stored at remote tape device 150.

FIG. 2 is a method for backing up data. First, metadata is stored on a local disc at step 210. At step 220, the data is stored on a local tape drive. Data may also be stored on a remote tape drive at step 230. A back-up event may be detected at step 240. Upon detecting the back-up event, the metadata may be stored on a remote disc drive at step 250. The backup event may be the expiration of a period of time, a user request, administrative request, or some other event.

FIG. 3 is a method for storing metadata at a remote server. First, metadata is accessed at step 310. Next, other data which is not backed up may be accessed by local data management server 130. The metadata and other data not backed up are then transmitted to remote data management server 160 at step 330. The data is received at the remote server at step 340. The metadata and other data is then stored at the remote file system at step 350.

FIG. 4 is a method for providing access to data upon a failed server. First, the customer accesses data from the local server at step 410. A detection is made that a local server has failed at step 420. The failure may be due to a natural or manmade disaster, catastrophe, or some other event that renders the local servers inoperable. The customer is provided with access to a remote system at 430.

FIG. 5 illustrates a block diagram for implementing servers 130 and 160 of the present invention. The computing system 500 of FIG. 5 includes one or more processors 510 and memory 520. Main memory 520 stores, in part, instructions and data for execution by processor 510. Main memory 520 can store the executable code when in operation. The system 500 of FIG. 5 further includes a mass storage device 530, portable storage medium drive(s) 540, output devices 550, user input devices 560, a graphics display 570, and peripheral devices 580.

The components shown in FIG. 5 are depicted as being connected via a single bus 590. However, the components may be connected through one or more data transport means. For example, processor unit 510 and main memory 520 may be connected via a local microprocessor bus, and the mass storage device 530, peripheral device(s) 580, portable storage device 540, and display system 570 may be connected via one or more input/output (I/O) buses.

Mass storage device 530, which may be implemented with a magnetic disk drive or an optical disk drive, is a non-volatile storage device for storing data and instructions for use by processor unit 510. Mass storage device 530 can store the system software for implementing embodiments of the present invention for purposes of loading that software into main memory 520.

Portable storage device 540 operates in conjunction with a portable non-volatile storage medium, such as a floppy disk, compact disk or Digital video disc, to input and output data and code to and from the computer system 500 of FIG. 5. The system software for implementing embodiments of the present invention may be stored on such a portable medium and input to the computer system 500 via the portable storage device 540.

Input devices 560 provide a portion of a user interface. Input devices 560 may include an alpha-numeric keypad, such as a keyboard, for inputting alpha-numeric and other information, or a pointing device, such as a mouse, a trackball, stylus, or cursor direction keys. Additionally, the system 500 as shown in FIG. 5 includes output devices 550. Examples of suitable output devices include speakers, printers, network interfaces, and monitors.

Display system 570 may include a liquid crystal display (LCD) or other suitable display device. Display system 570 receives textual and graphical information, and processes the information for output to the display device.

Peripherals 580 may include any type of computer support device to add additional functionality to the computer system. For example, peripheral device(s) 580 may include a modem or a router.

The components contained in the computer system 500 of FIG. 5 are those typically found in computer systems that may be suitable for use with embodiments of the present invention and are intended to represent a broad category of such computer components that are well known in the art. Thus, the computer system 500 of FIG. 5 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for backing-up data, comprising:
retrieving metadata associated with data stored on a local secondary storage system;
performing back-up of the secondary storage system to a remote secondary storage system;
accessing metadata from a local file system;
storing the metadata on a remote file system, at a separate location that the back-up version of the tape disk data.

2. The method of claim 1, further comprising providing customer access to the data on local secondary storage system and meta data on local file system.

3. The method of claim 1, further comprising detecting a failure at the local secondary storage and local file system.

4. The method of claim 1, further comprising the customer access to the data stored on the remote secondary storage and the metadata stored on the remote file system.

5. The method of claim 1, further comprising wherein the metadata is transmitted via a WAN.

6. The method of claim 1, further comprising storing the metadata on a remote file system in response detecting a back-up event.

7. The method of claim 1, wherein the back-up event is an expiration of a period of time.

8. The method of claim 1, wherein the back-up event is a user request.

9. A computer readable non-transitory storage medium having embodied thereon a program, the program being executable by a processor to perform a method for backing-up data, the method comprising:
retrieving metadata associated with data stored on a local secondary storage system;
performing back-up of the secondary storage system to a remote secondary storage system;
accessing metadata from a local file system;
storing the metadata on a remote file system, at a separate location that the back-up version of the secondary storage system data.

10. The computer readable non-transitory storage medium of claim 9, further comprising providing customer access to the data on local secondary storage system and meta data on local file system.

11. The computer readable non-transitory storage medium of claim 9, further comprising detecting a failure at the local secondary storage system and local file system.

12. The computer readable non-transitory storage medium of claim 9, further comprising the customer access to the data stored on the remote secondary storage system and the metadata stored on the remote file system.

13. The computer readable non-transitory storage medium of claim 9, further comprising wherein the metadata is transmitted via a WAN.

14. The computer readable non-transitory storage medium of claim 9, further comprising storing the metadata on a remote file system in response detecting a back-up event.

15. The computer readable non-transitory storage medium of claim 9, wherein the back-up event is an expiration of a period of time.

16. The computer readable non-transitory storage medium of claim 9, wherein the back-up event is a user request.
